(19) United States
(12) Patent Application Publication
(10) Pub. No.: US 2010/0003466 A1
(43) Pub. Date: Jan. 7, 2010

(54) Sound-Proofing Component and Method for the Production Thereof

(76) Inventor: Olaf Hessler, Obisfelde (DE)

Correspondence Address: Setter Roche LLP, P.O. Box 780, Erie, CO, 80516, US

(21) Appl. No.: 12/084,682

(22) PCT Filed: Nov. 10, 2006
(86) PCT No.: PCT/EP2006/010817

§ 371 Date: Aug. 28, 2009

(30) Foreign Application Priority Data
Nov. 11, 2005 (DE) 10 2005 053 946.7

(51) Int. Cl. G10K 11/168; B32B 5/02; B32B 5/24; B32B 3/28; B05D 3/02; B32B 3/26

(52) U.S. Cl. 428/175; 442/120; 442/374; 427/389.9; 264/134

(57) ABSTRACT

The invention relates to a sound-proofing component, particularly for absorbing noise in motor vehicles, comprising a first layer which is made of a nonwoven material, is embodied in a planar manner similar to a mat, and is provided with two opposite surfaces. A thin spray coating made of a duroplast, such as polyurethane and/or thermoplastic materials, is disposed on one of the outer surfaces of the nonwoven fabric. Also disclosed is a method for producing said component.

### FIELD OF THE INVENTION

The invention relates to a sound-proofing component, in particular for motor vehicles, and method for the production thereof.

### BACKGROUND OF THE INVENTION

It is known in automotive engineering to place nonwoven mats between the actual inner paneling, particularly in the region of the trunk, and the sheet metal components, for example the wheel housings, in order to achieve a damping of sound. These nonwoven mats are, for example, 0.2 to 3.0 cm thick nonwovens composed of natural or synthetic fibers. These nonwovens are made, for example, of factory scraps or rejects from the textile industry. In this process, clothing rejects are shredded and broken down into fibers, which are then processed to form a nonwoven.

It is known for such nonwoven mats to be adapted to or pressed against the outer contour of a vehicle interior, for example in the region of the wheel housings, by means of corresponding shaping machines and dies and then for them to be either placed loosely or glued onto the corresponding vehicle body parts.

It is also known to use so-called heavy-layer films for sound insulation or damping in motor vehicles. These heavy-layer films are plastic sheets or films that have a heavy additive added to them, e.g. barium sulfate. It is also known for bitumen plastic plates to be formed onto and placed against vehicle body parts in order to achieve an anti-drumming effect.

One object of the invention is to create a sound-proofing component, which is easy and quick to produce, can be easily shaped and installed, and also enables good sound-proofing.

Another object of the invention is to create a method for manufacturing the sound-proofing component with which the component can be produced easily, quickly, and inexpensively.

### SUMMARY OF THE INVENTION

The sound-proofing component is composed of an intrinsically known nonwoven, which has a plastic spray-coating on one side.

For example, the nonwoven is a nonwoven with a thickness of 5 to 20 mm, in particular 10 mm, and has densities from 30 kg/m² to 120 kg/m². Naturally, the nonwoven components can also be thicker. For example, the nonwoven component is a fiber flock material in which the actual nonwoven also contains PU flocks.

It can also be a thermoplastically bonded nonwoven component, which, in addition to the mixed or natural fibers such as wool or cotton that such nonwovens usually contain, also specifically contains a certain percentage of thermoplastic fibers that produce a bond by softening when subjected to a corresponding temperature treatment. Suitable fibers for this include polyolefin fibers such as polyethylene or polypropylene fibers, or polyester fibers or polyamide fibers. The component can, however, also be composed of purely natural fibers or purely synthetic fibers.

The spray coating is a continuous coating that is sprayed on and is composed of a thermoplastic or thermosetting plastic, in particular a polyurethane, that can be hard or soft. With polyurethane, it is very easy to adjust the desired hardness through the degree of cross-linking.

It has surprisingly turned out that even with a mass per unit area of only 50 g/m² of the spray coating, a very powerful sound-proofing effect is achieved, which would not be achievable by means of a corresponding film alone or by an increase in the mass per unit area of the nonwoven.

The boundary surface or layer here is open and permeable, thus providing a breathing action, which has a definite flow resistance.

The mass per unit area of the sprayed-on layer can be 50 g/m² or more; the spray coating, when it is particularly thin, is composed of polyurethane and with increasing layer thickness on the one hand, more material is applied. On the other hand, it is also possible to provide the plastic with foaming agents and in this way, to produce a thin foamed layer. This gives the spray coating a cellular structure.

The percentage of the foaming agent can be adapted to a desired property, in particular to a required insulating or absorbing action.

In comparative tests, in lieu of being sprayed on, the plastic was also rolled on in solution form or applied in spot fashion in paste form, but this did not produce the effects.

With the invention, it is advantageous that the spray coating can be applied very simply and inexpensively using existing technologies. It is also advantageous that even particularly thin layer thicknesses of a sprayed-on thermoplastic plastic, in particular a polyurethane, impart outstanding sound-insulation properties.

It is also advantageous that in comparison to other known coatings such as film coatings, laminations, and the like, processing can be carried out without tools.

It is also advantageous that depending on the layer thickness, the coating can be embodied with a cellular structure and in particular with an open-celled structure through the use of a foaming agent.

The invention will be explained in conjunction with the drawings.

### BRIEF DESCRIPTION OF THE DRAWINGS

FIG. 1 is a very schematic depiction of a nonwoven component, with a nonwoven region and a spray coating.

FIG. 2 shows a nonwoven component according to FIG. 1 in which the spray coating is foamed.

FIG. 3 shows various materials for nonwoven components according to the invention, with different absorption behaviors.

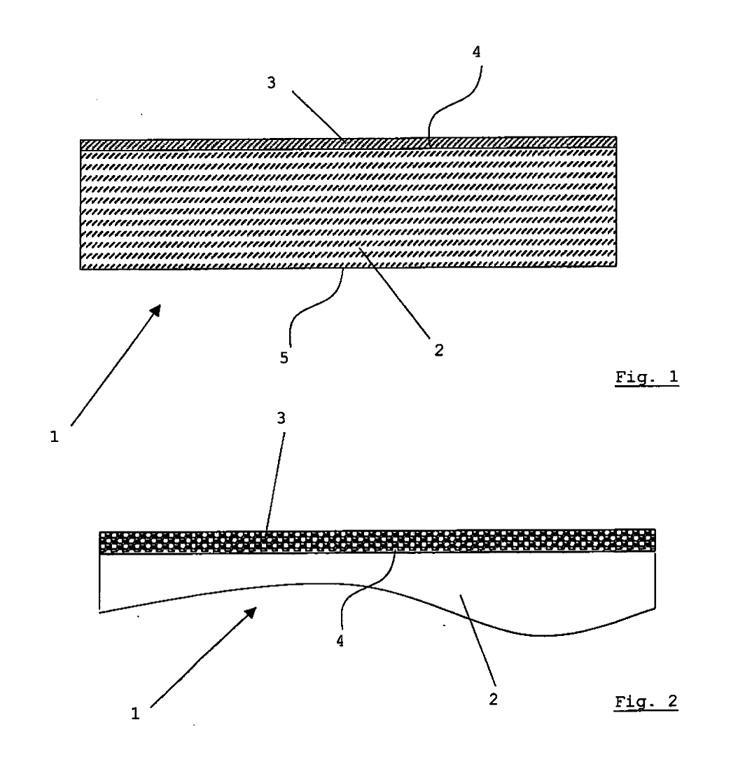

### DETAILED DESCRIPTION OF THE PREFERRED EMBODIMENTS

The component 1 according to the invention has a nonwoven component 2 and a spray coating 3. The spray coating 3 is sprayed onto a surface 4 of the nonwoven component 2 and has a mass per unit area of 50 to 1200 g/m².

The spray coating 3 is preferably composed of polyurethane whose degree of hardness is adjusted by means of the degree of cross-linking. The surface 4 onto which the coating is sprayed and the spray coating 3 itself can have or constitute a contoured surface, e.g. a knobbed, ribbed, or corrugated surface.

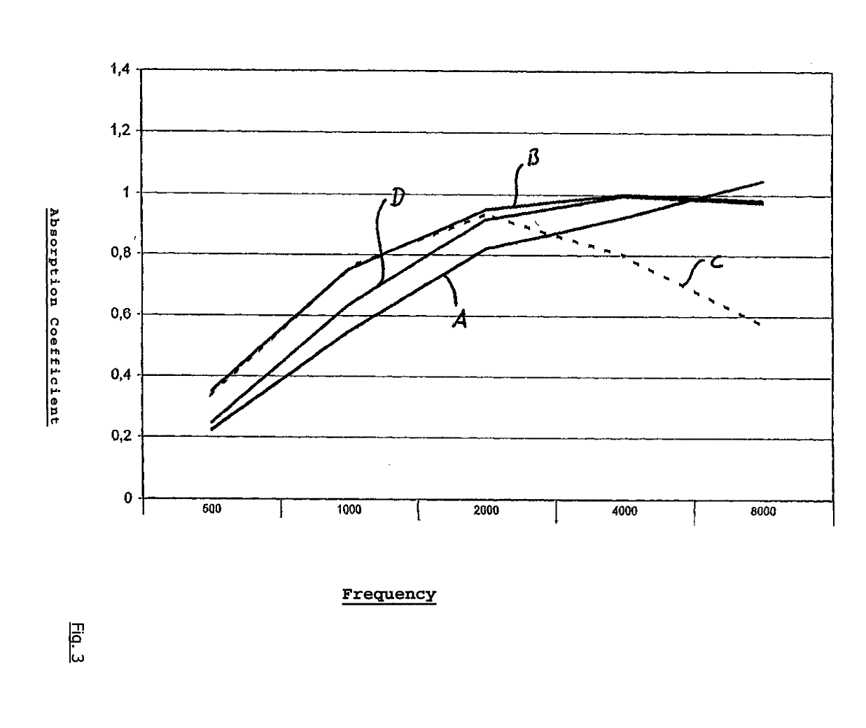

In another advantageous embodiment (shown enlarged in FIG. 2), the polyurethane spray coating is embodied in the form of an open-celled foamed spray coating 3 in which the open-celled structure is adjusted by means of a foaming agent in the PU material that is to be sprayed on.

The nonwoven component is a nonwoven component that can be manufactured in the known ways and can in this regard be a mat-like nonwoven, a needled nonwoven, or a thermally bonded nonwoven. In particular, it can be a thermoplastically bonded nonwoven in the form of a fiber flock nonwoven component or a thermoplastically strengthened nonwoven containing a certain percentage of thermoplastic fibers. The density of the nonwoven is variable and can also be additionally adjusted by means of the PU flock content. For example, the density of the nonwoven is 30 to 150 kg/m³.

The spray coating is open-celled and/or is open-pored and air permeable based on its thickness.

The mass per unit area of the spray coating is between 50 and 1200 g/m², depending on the application. This is also influenced by the surface area; when steps are taken that increase the surface area such as the provision of a knobby surface, a corrugated surface, or an otherwise contoured surface of the nonwoven component, this naturally also increases its weight.

The influence on the absorption behavior can also be clearly seen in FIG. 3.

In FIG. 3, the absorption curve, which is labeled A, is the absorption curve of a nonwoven component with a density of 90 kg/m³ and a thickness of 10 mm. The curve labeled B represents a minimum requirement.

The dot-and-dash curve C corresponds to a component according to the invention having a spray coating with a mass per unit area of 800 g/m², while curve D corresponds to a coating with a density or mass per unit area of 400 g/m².

It is clear here how powerful an influence the spray coating according to the invention has on the absorption behavior.

The sprayed surface 4 can be provided with a contour before or after the spraying. For example, a contour with lobes or knob-like projections is conceivable. Wavy or corrugated contours are also possible. It is additionally possible to provide the surface with a contouring in the form of a diamond lattice or waffle pattern. The opposite surface 5 of the nonwoven component 2 can likewise be provided with a corresponding contouring.

1. A component for sound-proofing and in particular for sound-proofing in motor vehicles, comprising:
a first layer of a nonwoven material, wherein the first layer is embodied in a flat, mat-like form and has two opposite surfaces; and
a thin spray coating of at least one of the group consisting of a thermoset plastic such as polyurethane, a thermoplastic polymer, and combinations thereof, applied to at least one of the two opposite surfaces of the first layer.

2. The component as recited in claim 1, wherein the spray coating has a mass per unit area of 50 to 1200 g/m².

3. The component as recited in claim 1, wherein the spray coating comprises a polyurethane whose degree of hardness is adjusted by its degree of cross-linking.

4. The component as recited in claim 1, wherein the spray coating is a foamed spray coating having an open-celled, porous structure.

5. The component as recited in claim 1, wherein the nonwoven layer is selected from the group consisting of: a mat-like nonwoven, a needled nonwoven, and a thermally bonded nonwoven; and the nonwoven layer is a fiber flock nonwoven layer and/or a thermoplastically strengthened nonwoven layer.

6. The component as recited in claim 1, wherein the density of the nonwoven layer is between 30 and 150 kg/m³.

7. The component as recited in claim 1, wherein the thickness of the nonwoven layer is 5 to 30 mm.

8. The component as recited in claim 1, wherein the surface of the nonwoven layer onto which the coating is sprayed or the spray coating itself has a contoured surface.

9. The component as recited in claim 8, wherein the surface of the nonwoven layer onto which the coating is sprayed is knobbed, ribbed, corrugated, or embodied with a waffle-like pattern.

10. The component as recited in claim 1, wherein the surface of the nonwoven layer situated opposite from the spray coating is contoured.

11. A method for manufacturing a sound-proofing component, in particular for sound-proofing in motor vehicles, comprising:
spraying one or two surfaces of a nonwoven layer or nonwoven component with at least one of the group consisting of a thermosetting plastic such as polyurethane and a thermoplastic polymer, which adheres to at least one of the surfaces, cross-links, and hardens.

12. The method as recited in claim 11, comprising adding a foaming agent to a polyurethane spray solution so that the polyurethane foams on the sprayed surface.

13. The method as recited in claim 11, further comprising contouring at least one of the surfaces of the nonwoven layer before or after the spraying.

14. The method as recited in claim 11, wherein the spray comprises polyurethane, and comprising using tools to bring the nonwoven component into a shape that corresponds to a particular application before or after the spraying and hardening of the polyurethane.

15. The method as recited in claim 11, wherein the spray comprises polyurethane and the consistency or hardness of the polyurethane layer is adjusted by its degree of cross-linking.
